(19) United States
(12) Patent Application Publication
(10) Pub. No.: US 2023/0079784 A1
(43) Pub. Date: Mar. 16, 2023

(54) METHOD FOR TESTING PEROVSKITE PRECURSOR SOLUTION

(71) Applicant: INDUSTRIAL TECHNOLOGY RESEARCH INSTITUTE, Hsinchu (TW)

(72) Inventors: Kuo-Wei Huang, Hsinchu (TW); Pei-Ting Chiu, Hsinchu (TW); Yung-Liang Tung, Hsinchu (TW); Po-Tsung Hsieh, Hsinchu (TW); Tai-Fu Lin, Hsinchu (TW)

(21) Appl. No.: 17/528,236

(22) Filed: Nov. 17, 2021

(30) Foreign Application Priority Data
Sep. 10, 2021 (TW) 110133878

(51) Int. Cl. G01N 23/20091; G01N 1/40; C07F 7/24

(52) U.S. Cl. CPC G01N 23/20091; G01N 1/4022; G01N 1/4077; C07F 7/24; G01N 2001/4088

(57) ABSTRACT

Provided is a method for testing a perovskite precursor solution, including: taking a perovskite precursor solution containing a plurality of dispersed perovskite colloids as a sample to perform liquid analysis, thereby obtaining an analysis information; and determining whether the perovskite precursor solution is a good product based on obtained analysis information from the liquid analysis, wherein the analysis information is at least one selected from the group consisting of element content of the colloid, element distribution, colloid size, and colloid appearance, thereby a feasible and effective testing method is defined through the correlation between the perovskite precursor colloid and the perovskite.

### CROSS-REFERENCE TO RELATED APPLICATION

The present application is based on, and claims priority from, Taiwan Application Serial Number 110133878, filed on Sep. 10, 2021, the disclosure of which is hereby incorporated by reference herein in its entirety.

### TECHNICAL FIELD

The present disclosure relates to a method for testing perovskite capable of being performed in a perovskite precursor solution before formation of a perovskite thin film.

### BACKGROUND

It has been found that perovskite materials have excellent photoelectric properties and are applied broadly in the fields of solar cells, lasers, light emitting diodes (LEDs), light emitting transistors (LETs), panel displays and the like. The structure of perovskite can be represented by ABX₃, wherein A is a central monovalent cation, and the octahedron (BX₆)⁴⁻ surrounds the central cation as a structural frame.

As the qualities of perovskite thin films and crystals are critical to the energy (photoelectric) conversion efficiency, it is needed to determine whether the qualities conform to the requirement by test or not. Currently, the method for testing perovskite is performed on formed perovskite thin films and crystals and belongs to the back-end process testing, in which the tested perovskite thin films and crystals have been subjected to several processes, and the exact causes cannot be directly found if a poor quality is tested or needs to improve, thus, a number of time and labor costs will be consumed to make a solution. Therefore, a method for testing perovskite precursor solution is needed.

### SUMMARY

The present disclosure provides a method for testing in the front-end process of perovskite, e.g., a method for testing a perovskite precursor solution, including:

taking a perovskite precursor solution containing a plurality of dispersed perovskite colloids as a sample to perform liquid analysis, thereby obtaining an analysis information; and

determining whether the perovskite precursor solution is a good product based on the analysis information obtained from the liquid analysis,

wherein the analysis information is at least one selected from the group consisting of element content of the colloid, element distribution, colloid size, and colloid appearance.

### BRIEF DESCRIPTION OF THE DRAWINGS

FIG. 1A is a graph showing the energy conversion efficiency curves of solar cells prepared in Example 2 by forming perovskite thin films from various perovskite precursor solutions at different times and further preparing solar cells.

FIGS. 1B to 1G are scanning electron microscope (SEM) images of various perovskite precursor solutions at different times.

FIG. 2A is an SEM image of a good product of the perovskite precursor solution in Example 3.

FIG. 2B is the result of the energy-dispersive X-ray (EDX) analysis on its perovskite colloid.

FIG. 3A is an SEM image of a bad product of the perovskite precursor solution in Example 3.

FIG. 3B is the result of EDX analysis on its perovskite colloid.

FIGS. 4A to 4C are graphs showing the energy conversion efficiency curves, I atomic percentage curves, and Pb atomic percentage curves of the perovskite precursor solutions containing different brands of lead iodide (Alfa and TCI) at different times in Example 3.

FIG. 5 shows an SEM image and an EDX mapping data image of a good product of the perovskite precursor solution in Example 4.

FIG. 6 shows EDX mapping data images of a good product and a bad product of the perovskite precursor solution in Example 5.

FIG. 7A is an SEM image of a good product of the perovskite precursor solution in Example 6.

FIG. 7B is the result of EDX analysis on its perovskite colloid.

FIG. 8A is an SEM image of a bad product of the perovskite precursor solution in Example 6.

FIG. 8B is the result of EDX analysis on its perovskite colloid.

FIGS. 9 and 10 are SEM images (300X) of a good product of the perovskite precursor solution in Example 7.

FIG. 11 shows SEM images (300X) of a bad product of the perovskite precursor solution in Example 7.

### DETAILED DESCRIPTION

The execution modes of the present disclosure are illustrated by particular embodiments, and a person having the ordinary skill in the technical field to which the present disclosure belongs can readily appreciate the scope and efficacy of the present disclosure based on the content recorded herein. However, the embodiments recorded herein are not intended to limit the present disclosure. The technical features or schemes listed can be combined with one another. The present disclosure can be implemented or applied by other different execution modes. Details recorded herein can be altered or modified differently according to different viewpoints and applications without departing from the present disclosure.

Unless stated otherwise, “comprising”, “containing” or “having” particular elements used herein means that other elements such as units, components, structures, regions, parts, devices, systems, steps, or connection associations can be also included rather than excluded.

Unless expressly stated otherwise, the singular forms “a”, “an” and “the” also include the plural forms, and the “or” and “and/or” can be used interchangeably herein.

The value ranges recited herein are inclusive and can be combined, and any value falling into the value range recited herein can be used as the upper or lower limit to derive a subrange; for example, a value range of “50° C. to 150° C.” should be understood to include any subrange from a lower limit of 50° C. to an upper limit of 150° C., e.g., subranges of 60° C. to 150° C., 50° C. to 140° C., and 60° C. to 140° C. and so on. In addition, a value should be considered to be included in the range of the present disclosure if the value falls into a range recited herein (e.g., 100° C. falls into the range of from 50° C. to 150° C.).

In order to prepare perovskite films and crystals, in general, various raw materials for perovskite are mixed with a solvent and subjected to reaction to form a perovskite precursor solution which is then coated on a substrate for film formation. In the perovskite precursor solution, the raw materials are not actually dissolved indeed but form dispersed colloids with small sizes. Since the colloids largely affect the formation and properties of perovskite, therefore, it is one of the purposes of the present disclosure to directly test the perovskite precursor solution, especially the colloid therein, and to further conclude the association of the colloid with perovskite.

In a first exemplary embodiment, the present disclosure provides a method for testing a perovskite precursor solution, including: taking a perovskite precursor solution containing a plurality of dispersed perovskite colloids as a sample to perform liquid analysis, thereby obtaining an analysis information; and determining whether the perovskite precursor solution is a good product based on the analysis information obtained from the liquid analysis, wherein the analysis information is at least one selected from the group consisting of element content of the colloid, element distribution, colloid size, and colloid appearance.

As a solvent system suitable for testing, the solvent system of the original sample can be used directly, which includes but not limited to well-known dimethyl sulfoxide (DMSO), dimethyl formamide (DMF), γ-butyrolactone (GBL), N-methylpyrrolidinone (NMP) and the combination thereof. In addition, the sample can be further diluted or concentrated to adjust it to an applicable testing concentration. The dilution can be done by using the same solvent system as that of the original sample or adding different solvents, which can be adjusted suitably according to actual requirement and, the present disclosure is not limited thereto. In an embodiment, the solvent system is a mixed solvent of GBL/DMSO or DMF/DMSO.

In order to test a perovskite precursor solution sample in liquid state by using an instrument, the sample can be dropped into a carrier box which is then glued by a lid to seal the sample in the carrier box. In one embodiment, the temperatures of the carrier box and the sample are maintained between 25° C. and 50° C. during sealing, after sealing and during testing, to further avoid perovskite crystal precipitation which will affect the testing effect.

The source of element contents, element distribution, colloid size and colloid appearance can be any liquid analysis method capable of acquiring analysis information as described above, and as examples, the present disclosure has enumerated a scanning electron microscope (SEM) analysis, an energy dispersive X-ray (EDX) analysis and an EDX mapping data image, but not limited thereto, any instrument or analysis method are applicable in the testing method of the present disclosure as long as it is suitable for testing liquid and the analysis information listed in the present disclosure can be observed.

By repeated verifications, the present disclosure confirms that there is a particular association of the colloid appearance in the perovskite precursor solution with the perovskite thin film or crystals formed therefrom, wherein it can be seen from the analysis information (e.g., an SEM image) about colloid size of the perovskite precursor solution. If the average size of the perovskite colloids falls into a particular range, the perovskite formed therefrom has a preferable energy conversion efficiency. In an embodiment, the perovskite precursor solution is determined to be a good product if the perovskite colloids have an average size between 4 μm and 15 μm, specifically, 4 μm, 5 μm, 6 μm, 7 μm, 8 μm, 9 μm, 10 μm, 11 μm, 12 μm, 13 μm, 14 μm, or 15 μm. On the other hand, when the average size of the perovskite colloids does not fall into the aforementioned particular range, it is determined to be a bad product and the formed perovskite has lower energy conversion efficiency. In an embodiment, the perovskite precursor solution is also determined to be a good product if more than 80% of the perovskite colloids have a colloid size of between 4 μm and 15 μm, otherwise, it is determined to be a bad product.

In the present disclosure, it can also be seen from the analysis information (e.g., an SEM image) about colloid appearance of the perovskite precursor solution. If the perovskite colloid has a spherical appearance, the perovskite formed therefrom has preferable energy conversion efficiency. In an embodiment, the spherical appearance refers to a shape conforming to [(b/a)+(c/a)]/2≥80%, and the perovskite precursor solution is determined to be a good product if the perovskite colloid has an appearance conforming to [(b/a)+(c/a)]/2≥80%, wherein a, b and c are the largest radius, the second largest radius and the smallest radius of the perovskite colloid, respectively. In other embodiments, the spherical shape also refers to a shape conforming to [(b/a)+(c/a)]/2≥85% or [(b/a)+(c/a)]/2≥90%. Otherwise, when the perovskite colloid is non-spherical, e.g., collapsed agglomerate, the formed perovskite has lower energy conversion efficiency.

The spherical appearance of the perovskite colloid also can be determined by an SEM image with a low magnification such as less than 500×, specifically, 300×. The image is divided averagely into 9 regions and each region is determined whether more than 80% of the perovskite colloids have a completely spherical appearance (i.e., [(b/a)+(c/a)]/2≥80%, wherein a, b and c are the largest radius, the second largest radius and the smallest radius of the perovskite colloid, respectively). The perovskite precursor solution is determined to be a good product if, in more than or equal to 4 regions of the 9 regions, more than 80% of the perovskite colloids have a completely spherical appearance, otherwise, it is determined to be a bad product.

The testing method of the present disclosure is suitable for testing various perovskite colloids which are the precursors of various perovskite. The perovskite can be unitary perovskite, binary perovskite and ternary perovskite, and can be all-inorganic perovskite, all-organic perovskite and hybrid organic-inorganic perovskite. The perovskite can be represented by ABX₃, wherein A represents at least one monovalent cation selected from the group consisting of M₁, M₂ and M₃, M₁ is an amine compound unsubstituted or substituted with a C₁₋₂₀ alkyl or a C₆₋₂₀ aryl, M₂ is an amidine compound unsubstituted or substituted with a C₁₋₂₀ alkyl or a C₆₋₂₀ aryl, and M₃ is at least one element selected from the group consisting of Cs, Rb, Li and Na; B represents at least one element selected from the group consisting of Ca, Bi, Sr, Cd, Cu, Ni, Mn, Fe, Co, Pd, Ge, Sn, Pb, Sn, Yb and Eu, and X represents at least one element or group selected from the group consisting of halogen, SCN and OCN. In at least one embodiment, the perovskite is ternary perovskite, and A includes monovalent cations of M₁, M₂ and M₃, wherein M₁, M₂ and M₃ are defined as above. In an embodiment, the perovskite is ternary perovskite. In another embodiment, the ternary perovskite is (MAₓFA_{y}Cs_{1-x-y})Pb(BrₐI₁₋ₐ)₃, wherein MA is CH₃NH₃⁺, FA is HC(═NH)NH₂⁺, x, y and a are equal to or less than 1, and 0.1<1−x−y<0.5.

The perovskite colloid is a precursor for preparing perovskite, which provides multiple elements including aforementioned A, B, X and the like for perovskite. The present disclosure shows that, in a perovskite precursor solution, if the particular elements in perovskite colloid have contents in particular ranges, the formed perovskite exhibits preferable energy conversion efficiency. In an embodiment, “the particular elements in perovskite colloid have contents in particular ranges” refers to the element represented by B has a content of more than 5% and/or the halogen or sulfur in the element or group represented by X has an element content of more than 10%, wherein when X is SCN, the element tested is sulfur. The perovskite precursor solution is determined to be a good product if the element represented by B in the perovskite colloid has a content of more than 5% and/or the halogen or sulfur in the element or group represented by X has an element content of more than 10%. In other embodiments, the element represented by B (e.g., Pb) has a content of more than 6%, more than 7%, or more than 8%, the halogen or sulfur in the element or group represented by X (e.g., F, Cl, Br, I, S) has an element content of more than 12%, 15%, or more than 20%. Specifically, the element represented by B (e.g., Pb) can have a content of 5.5%, 6%, 6.5%, 7%, 7.5%, 8%, 8.33%, 8.36%, 8.5%, 9%, 9.5%, or 10%, and the halogen or sulfur in the element or group represented by X (e.g., F, Cl, Br, I, S) can have an element content of 11%, 12%, 13%, 14%, 15%, 16%, 17%, 18%, 19%, 20%, 20.37%, 20.69%, 21%, 22%, 23%, 24%, or 25%. On the other hand, when the content of a particular element in the perovskite colloid does not fall into the aforementioned particular range, the formed perovskite has lower energy conversion efficiency. One of the possible reasons is the perovskite precursor solution cannot form a proper colloid (e.g., colloid collapses due to insufficient surface energy) and elements leach into the solvent, resulting in a too low content of particular elements in the perovskite colloid.

The SEM image overlapping with the EDX mapping data image can be used for determining whether the positions of perovskite colloid overlap with the dominant distribution positions of a characteristic element contained in the perovskite to be formed. The present disclosure confirmed that, if overlapping between the two, the perovskite precursor solution is determined to be a good product and the formed perovskite has a preferable energy conversion efficiency. For example, the characteristic element in the (FA_{0.8}MA_{0.15}Cs_{0.05})Pb(Br_{0.15}I_{0.85})₃ perovskite can be chosen as at least one of Pb, Cs, Br, and I. On the other hand, when the positions of perovskite colloid do not overlap or do not completely overlap with the dominant distribution positions of a characteristic element contained in the perovskite to be formed, the energy conversion efficiency of perovskite formed becomes worse, suggesting that the colloid collapses and the elements diffuse into the solvent, resulting in poor quality of the formed perovskite.

It can be determined whether the perovskite precursor solution has been contaminated from the analysis information about element distribution such as an EDX mapping data image. In an embodiment, in order to determine whether the perovskite precursor solution is intruded by oxygen, the element distribution image (e.g., EDX mapping data image) is divided averagely into two regions (such as along the diagonal or the mid-line of the long side), and the perovskite precursor solution is determined to be a good product if the difference between the average intensities of the oxygen element in the two regions is ≤5 folds, otherwise, it is determined to be a bad product. In other embodiments, a stricter criterion can be set, for example, the perovskite precursor solution is determined to be a good product if the difference between the average intensities of the oxygen element in the two regions is ≤4.5 folds, ≤4 folds, ≤3.5 folds, or ≤3 folds, otherwise, it is determined to be a bad product.

A second exemplary embodiment of the present disclosure is based on the testing method of the first exemplary embodiment, and the sample is further subjected to pretreatments prior to the liquid analysis. The pretreatments include heating, oscillating and filtering the sample.

The pretreatments are for removal of precipitated small crystals and impurities from the perovskite precursor solution to facilitate subsequent testing. In an embodiment, the heating is performed by elevating the temperature of the sample to a range of from 50° C. to 150° C.; in an embodiment, the oscillating is, for example, ultrasonic oscillation; in an embodiment, the filtering is performed by allowing the sample to pass through a screen of 0.1 μm to 1 μm.

In an embodiment, the pretreatments further include the secondary heating; in another embodiment, the secondary heating is performed at a temperature below that in the first heating step, e.g., by elevating the temperature of the sample to a range of from 40° C. to 80° C.

In an embodiment, the pretreatments include heating, oscillating, secondary heating and filtering the sample in sequence.

In the present disclosure, the perovskite precursor solution samples are maintained in contact with pure nitrogen gas or an inert gas to avoid contacting with oxygen and causing oxygen element intrusion.

Further details will be described in the present disclosure by referencing to following Examples which are never in any sense intended to limit the scope of the present disclosure.

### EXAMPLES

### Example 1: Solvents and Pretreatment Temperature

The solvent system suitable for the testing method of the present disclosure is preferably such a solvent system as GBL, DMSO, DMF, NMP and the like, while the use of other solvent systems containing ethers or alcohols usually results in crystal precipitation or crystal agglomeration which impacts the analysis and determination on the colloid.

A part of (FA_{0.8}MA_{0.15}Cs_{0.05})Pb(I_{0.85}Br_{0.15})₃ perovskite precursor solution (solvent: GBL/DMSO) was taken and subjected to pretreatments including the first stage of heating at 70° C., ultrasonic oscillation, the second stage of heating at 65° C., screening at room temperature and so on. The sample after the aforementioned pretreatments exhibited no deterioration. The same precursor solution was otherwise heated in the first stage of heating to above 150° C., and formation of a number of black small particles of perovskite and partially needle-like lead iodide were produced from the sample, showing that such sample was no longer suitable for liquid analysis.

### Example 2: Colloid Size and Colloid Appearance of the Perovskite Precursor Solution were Obtained by Liquid Analysis and Linked to the Energy Conversion Efficiency of a Solar Cell Containing the Perovskite

A plurality of perovskite precursor solutions containing different brands of lead iodide (Alfa and TCI) were prepared, each of which can form a hybrid organic-inorganic ternary perovskite with the structure of (FA_{0.8}MA_{0.15}Cs_{0.05})Pb(Br_{0.15}I_{0.85})₃. The solvent systems of the perovskite precursor solutions employed toxic: DMF/DMSO or nontoxic: GBL/DMSO and were kept in N₂ (nitrogen environment) or ambient (atmosphere environment).

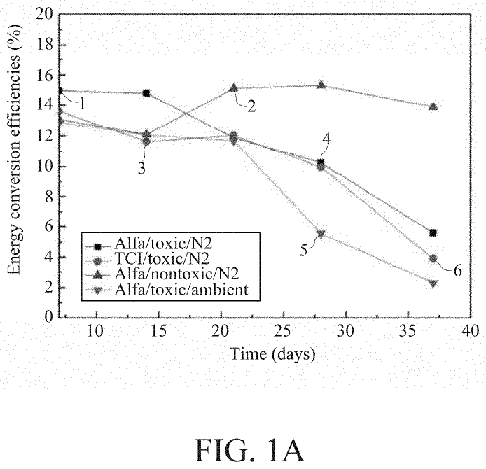

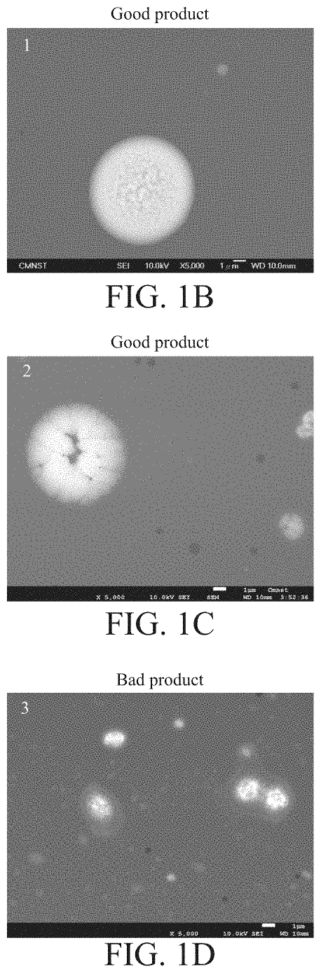

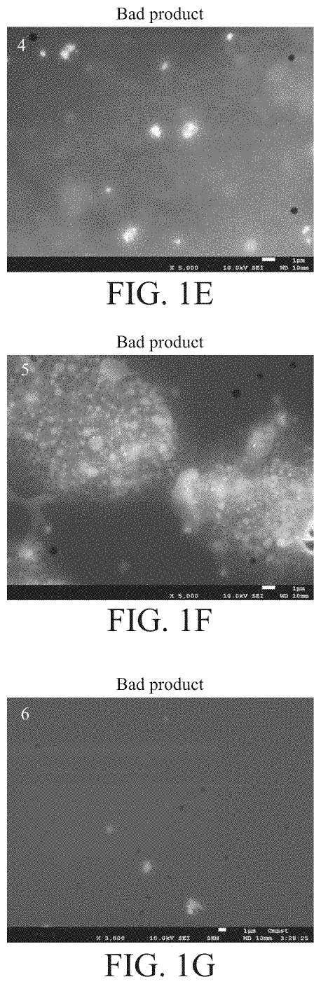

In general, after a perovskite precursor solution is prepared, it is immediately subjected to subsequent perovskite thin film formation, as there is no technique for testing perovskite precursor solution directly in the past and it cannot be confirmed whether the perovskite precursor solution is stable over time or not intruded by oxygen. Through the testing method of the present disclosure, the quality of a perovskite precursor solution can be determined, therefore, in Example 1, the aforementioned perovskite precursor solutions were stored and subjected to subsequent perovskite thin film formation after storing for different periods. Prior to the perovskite thin film formation, a portion of the perovskite precursor solution was taken, and it was subjected to the pretreatments, and packaged into a test sample. Thus, SEM images of the perovskite precursor solutions after storing for different periods can be observed and were shown in FIGS. 1B-1G, and the analysis information about colloid sizes was obtained from the images.

On the other hand, the perovskite thin film was further processed into a perovskite solar cell with the structure of FTO/b-TiO₂/m-TiO₂/perovskite/spiro-OMeTAD/Au, the energy conversion efficiency of the solar cell was tested and the results was shown in FIG. 1A, wherein FTO is fluorine-doped tin oxide, b-TiO₂ is a TiO₂ barrier layer, m-TiO₂ is mesoporous TiO₂, spiro-OMeTAD is 2,2′,7,7′-tetrakis[N,N-di(4-methoxyphenyl)amino]-9,9′-spirobifluorene.

FIG. 1A shows that the perovskite thin films prepared from the perovskite precursor solution after storing for different periods would affect the energy conversion efficiencies. In FIGS. 1A and 1B-1G, Nos. 1 and 4 are the liquid analytical samples of Alfa/toxic/N₂ perovskite precursor solutions stored for respectively 7 and 28 days after preparation, and the energy conversion efficiencies of the solar cells prepared from them; No. 2 is the liquid analytical sample of Alfa/nontoxic/N₂ perovskite precursor solution stored for 21 days after preparation and the energy conversion efficiency of the solar cell prepared from them; Nos. 3 and 6 are the liquid analytical samples of TCI/toxic/N₂ perovskite precursor solutions after preparation, which are stored for 14 and 37 days, respectively, and the energy conversion efficiencies of the solar cells prepared from them; and No. 5 is the liquid analytical sample of Alfa/toxic/ambient perovskite precursor solution stored for 28 days after preparation and the energy conversion efficiency of the solar cell prepared from them.

According to the results in FIGS. 1A and 1B, the absolute diameters of the colloid were observed to be 10 μm in the images of Nos. 1 and 2, and the energy conversion efficiencies of the perovskite solar cells of Nos. 1 and 2 were up to more than 14%. On the other hand, the absolute diameter of the colloid was less than 3 μm in the image of No. 3, the absolute diameter of the colloid was less than 1 μm in the images of Nos. 4-6, and the energy conversion efficiencies of the perovskite solar cells of Nos. 3-6 were lower, less than 12%. It was shown that the colloid size was associated with the energy conversion efficiency of the perovskite solar cell, when the colloid size of the perovskite precursor solution was too small, the energy conversion efficiency of the perovskite solar cell also became worse.

On the other hand, the colloid appearance of Nos. 1, 3 and 4 was observed. For No. 1, [(b/a)+(c/a)]/2=89.5%, which exhibited spherical appearance. However, for Nos. 3 and 4, the values of [(b/a)+(c/a)]/2 were 52.6% and 64.3%, respectively, which were non-spherical appearance. The results described above showed that the colloid appearance was associated with the energy conversion efficiency of the perovskite solar cell. When the colloid of the perovskite precursor solution had spherical appearance, the energy conversion efficiency of the perovskite solar cell was preferable, otherwise, the energy conversion efficiency of the perovskite solar cell became worse. The present disclosure set a criterion of [(b/a)+(c/a)]/2≥80% based on the association, the perovskite precursor solution conforming to this criterion was determined as a good product, otherwise, as a bad product.

### Example 3: Element Contents of the Perovskite Precursor Solution were Obtained by Liquid Analysis and Linked to the Energy Conversion Efficiency of a Solar Cell Containing the Perovskite

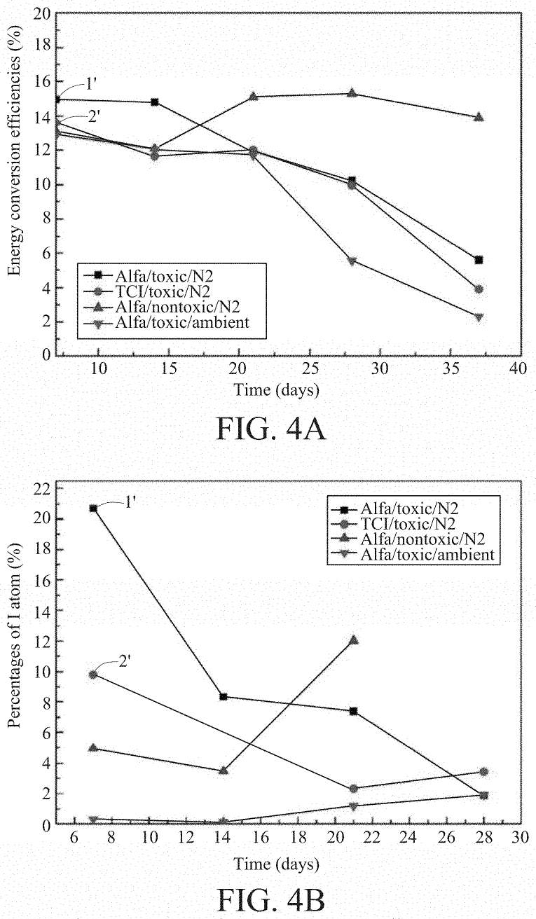

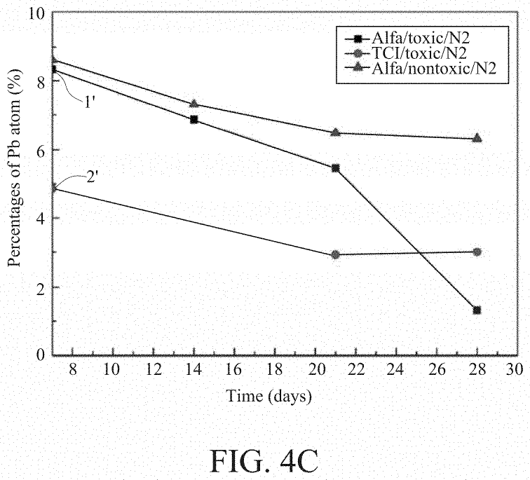

Various perovskite precursor solution samples were prepared in the same manner as in Example 2 and subjected to subsequent processes to obtain perovskite solar cells, the energy conversion efficiencies of the perovskite solar cells were acquired as shown in FIG. 4A. Further, in order to observe the association of the element contents in the colloid with the energy conversion efficiency of the perovskite solar cell, EDX analysis was performed on the colloid of each perovskite precursor solution sample, and the acquired contents of I element and Pb element in the colloid were summarized in FIGS. 4B and 4C.

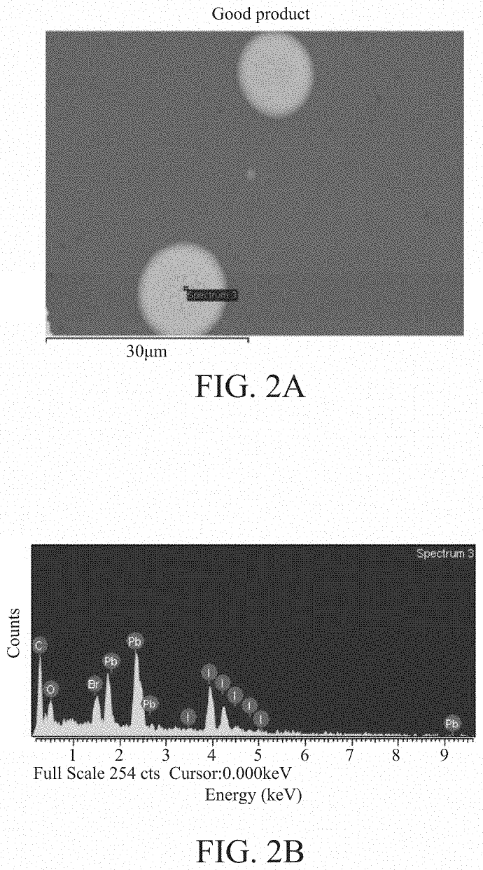

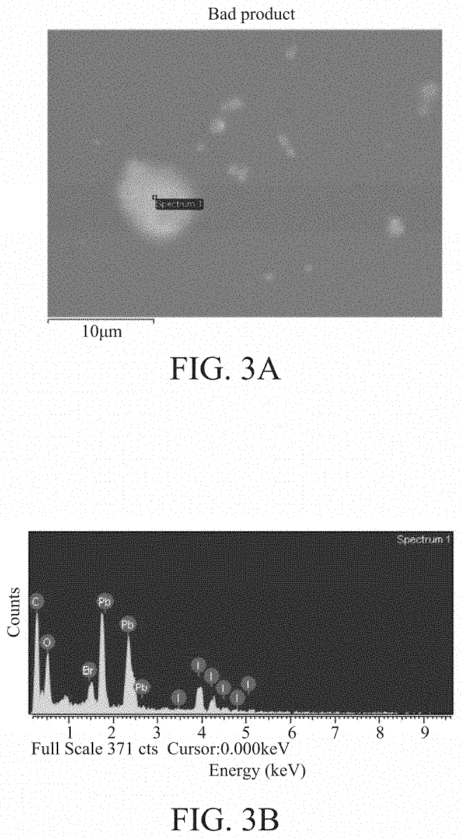

In addition, SEM images of colloids of No. 1′ (Alfa/toxic/N₂ perovskite precursor solution stored for 7 days after preparation) and No. 2′ (TCI/toxic/N₂ perovskite precursor solution stored for 7 days after preparation) solution samples were captured, and the results were shown in FIGS. 2A and 3A; EDX analyses were performed on the colloids to obtain the analysis information about element contents in the colloids, and the results were shown in FIGS. 2B and 3B.

It can be seen from the results in FIGS. 2A, 2B, 3A, 3B and 4A-4C, No. 1′ sample (Alfa/toxic/N₂ group stored for 7 days) contained I element at a content of about 21% and Pb element at a content of about 8%, and the energy conversion efficiency of the corresponding perovskite solar cell was about 15%; the sample of Alfa/nontoxic/N₂ group stored for 21 days contained I element at a content about 12% and Pb element at a content about 7%, and the energy conversion efficiency of the corresponding perovskite solar cell was about 15%. In contrast, No. 2′ sample (TCI/toxic/N₂ group stored for 7 days) contained I element at a content less than 10% and Pb element at a content less than 5%, and the energy conversion efficiency of the corresponding perovskite solar cell was less than 14%. These results showed that when I element and/or Pb element was/were at lower content(s), the energy conversion efficiency of the corresponding perovskite solar cell became worse. Combining the above results, we can get an association that when the content of I element was more than 10% and/or the content of Pb element was more than 5%, the energy conversion efficiency of the perovskite solar cell was better.

### Example 4: Element Distribution of the Perovskite Precursor Solution was Obtained by Liquid Analysis

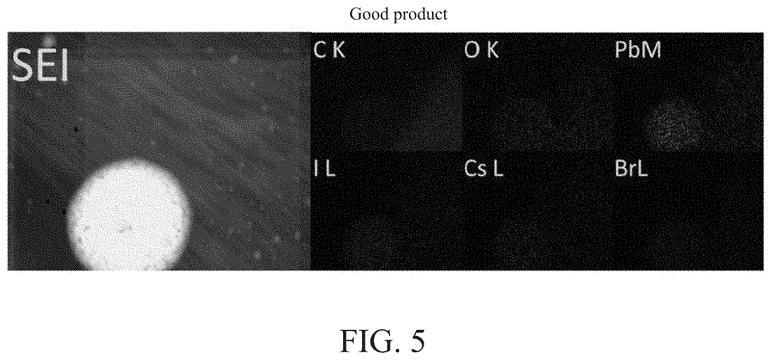

Perovskite precursor solution samples were prepared in the same manner as in Example 2, and SEM and EDX mapping data images of the perovskite precursor solutions were acquired as shown in FIG. 5 to get the analysis information about element distribution.

Aforementioned Examples 2 and 3 confirmed that the colloid appearance and colloid element contents were associated with the energy conversion efficiency of the corresponding perovskite solar cell, i.e., the better the colloid formed, the higher the energy conversion efficiency of the corresponding perovskite solar cell was. Thus, overlapping a SEM image (showing positions of the colloid) with an EDX mapping data image (showing the distribution position of each element) can also be used for determining whether a colloid was formed well. As shown in FIG. 5, the positions of colloid overlapped with the dominant distribution positions of Pb, Cs, Br and I elements, demonstrating that no element leached into the solvent, thereby determining that colloid was formed well.

### Example 5: Element Distribution of the Perovskite Precursor Solution was Obtained by Liquid Analysis

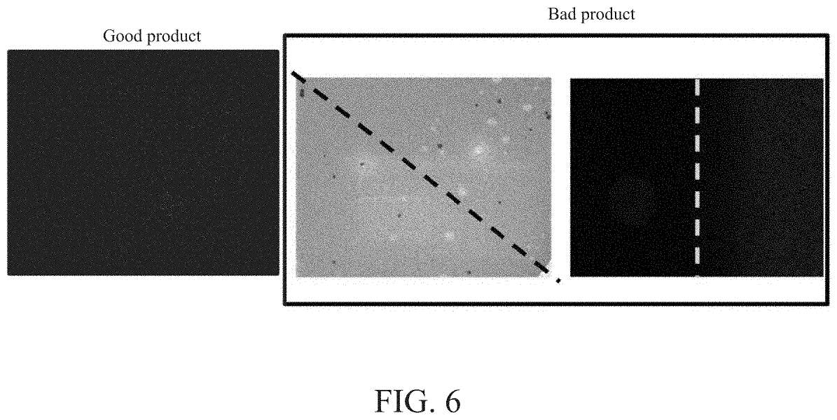

Perovskite precursor solution samples (including good and bad products) were prepared in the same manner as in Example 2, and EDX mapping data images of the perovskite precursor solutions were acquired as shown in FIG. 6 to get the analysis information about oxygen element distribution.

The intrusion of oxygen element into the perovskite precursor solution would cause adverse effects. The present disclosure observed the oxygen element distribution and set determination criteria to determine the quality of a perovskite precursor solution. The EDX mapping data image was divided averagely into two regions along the diagonal or the mid-line of the long side, and the perovskite precursor solution is determined to be a good product if the difference between the average intensities of the oxygen element in the two regions is ≤5 folds, otherwise, it is determined to be a bad product. It was confirmed that the solar cell prepared from the good product of perovskite precursor solution had an energy conversion efficiency of more than 14%. In contrast, the solar cell prepared from the bad product of perovskite precursor solution with oxygen element intrusion had an energy conversion efficiency significantly of less than 14%, which was only about 8%.

### Example 6: Element Contents of the Perovskite Precursor Solution were Obtained by Liquid Analysis and Linked to the Energy Conversion Efficiency of a Solar Cell Containing the Perovskite

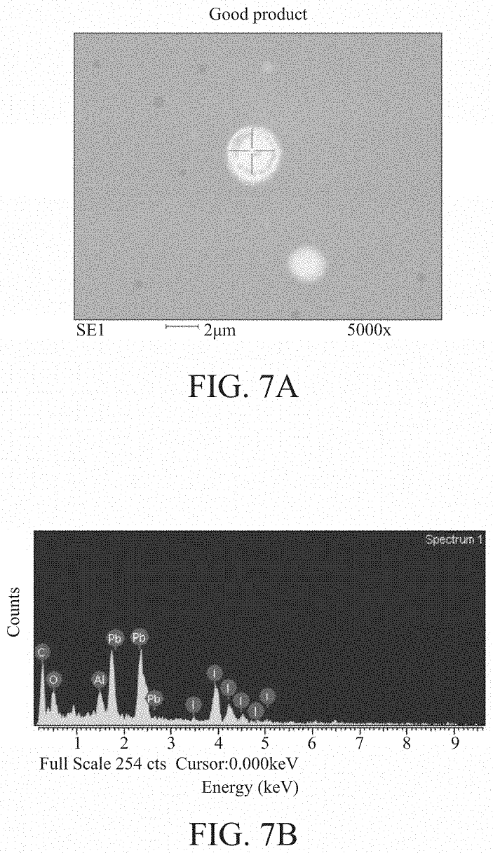

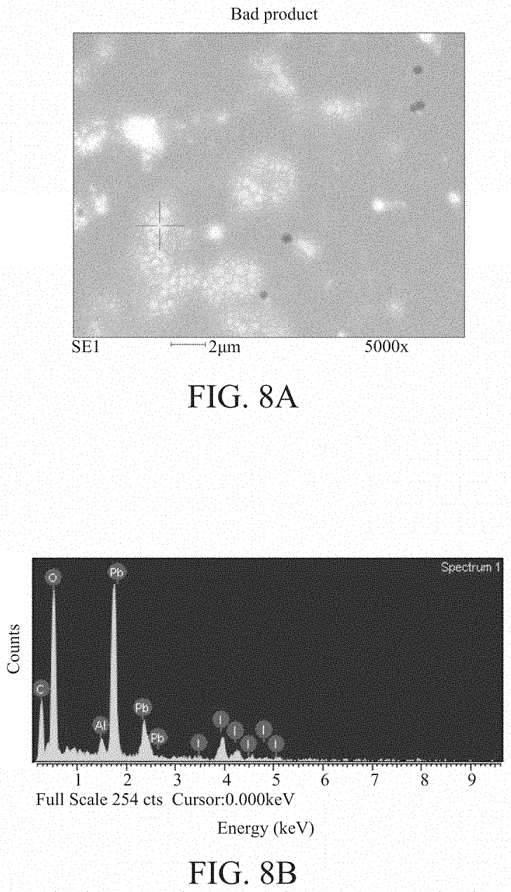

Two perovskite precursor solutions (including good and bad products) were prepared and both can form unitary all-organic perovskite with the structure of MAPbI₃, the solvent system of the perovskite precursor solutions employed GBL/DMSO. A portion of each perovskite precursor solution was taken and packaged to form a test sample, SEM images were captured and the results were shown in FIGS. 7A and 8A, and EDX analysis was performed on the colloids to obtain element contents of colloid and the results were shown in FIGS. 7B and 8B. Meanwhile, perovskite solar cells with the structure of FTO/b-TiO₂/m-TiO₂/perovskite/spiro-OMeTAD/Au were prepared from the residual perovskite precursor solutions and were tested for their energy conversion efficiencies. The perovskite solar cells produced from the samples of FIGS. 7A and 7B had energy conversion efficiencies of 16.1%, and the perovskite solar cells made from the samples of FIGS. 8A and 8B had energy conversion efficiencies of 9.8%.

FIG. 7B showed that the colloid of the sample contained Pb element at a content of 8.36% and I element at a content of 20.37%, and the formed perovskite solar cell exhibited a high energy conversion efficiency. In contrast, FIG. 8B showed that the colloid of the sample contained Pb element at a content of 2.33% and I element at a content of 7.04%, and the formed perovskite solar cell exhibited a low energy conversion efficiency. On the other hand, the colloid in FIG. 7A had [(b/a)+(c/a)]/2=96.6%, which belonged to spherical appearance, whereas the colloid in FIG. 8A had [(b/a)+(c/a)]/2=65.1%, which exhibited non-spherical appearance. Therefore, the determination criteria for the ternary perovskite precursor solution aforementioned in the present disclosure are also suitable for unitary perovskite precursor solution.

### Example 7: Colloid Appearance of the Perovskite Precursor Solution was Obtained by Liquid Analysis and Linked to the Energy Conversion Efficiency of a Solar Cell Containing the Perovskite

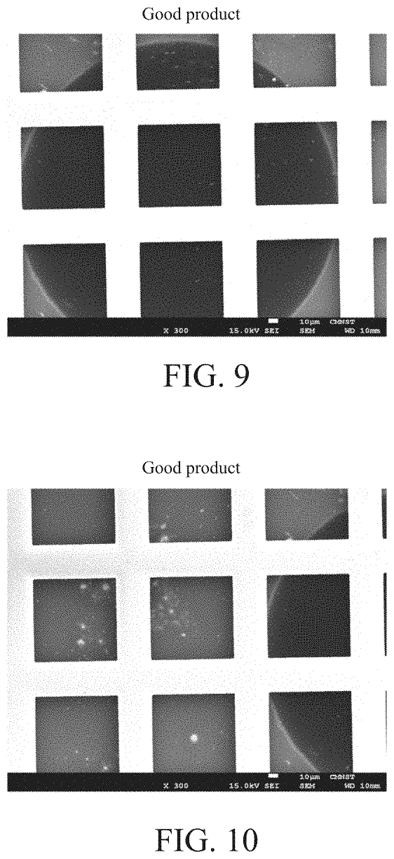

Three perovskite precursor solution samples and perovskite solar cells were prepared in the same manner as in Example 2, and liquid analysis was performed on the perovskite precursor solution samples to obtain the SEM images in FIGS. 9-11. The SEM images were captured using a lens with the lower magnification of 300× (the black area was the carrier box bottom background and had no effect on determination). The perovskite solar cells corresponding to the samples of FIGS. 9-11 have energy conversion efficiencies of 16.1%, 14.5% and 9.8%, respectively.

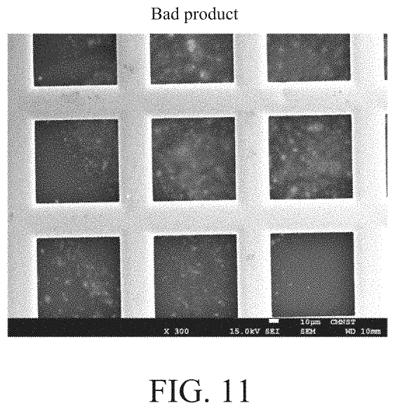

The SEM image with the lower magnification was divided into 9 regions and determined whether more than 80% of colloids in each region had spherical appearance, i.e., whether more than 80% of colloids conformed to [(b/a)+(c/a)]/2≥80%, was determined. In FIG. 9, in the 3 regions of the middle row, and the middle and the right regions of the bottom row, more than 80% of the colloids had the spherical appearance, in other words, colloids in 5 of 9 regions of the SEM image with the low magnification had the spherical appearance. And, the perovskite solar cell corresponding thereto had an energy conversion efficiency of 16.1%. FIG. 10 is an SEM image with the low magnification of another sample, wherein in 4 regions (the left region of the top row, the right region of the middle row, and the left and middle regions of the bottom row), more than 80% of the colloids had the spherical appearance, and the perovskite solar cell corresponding thereto had an energy conversion efficiency of 14.5%. In contrast, FIG. 11 is an SEM image with the low magnification of still another sample. Of 9 regions, only in the right one of the bottom row, more than 80% of the colloids had the spherical appearance, and the perovskite solar cell corresponding thereto had an energy conversion efficiency of 9.8% only. Accordingly, the association of the proportion of regions of 9 regions conforming to that more than 80% of colloids have spherical appearance with the energy conversion efficiency of perovskite solar cell corresponding thereto can be observed, thereby a determination criterion can be set: the perovskite precursor solution is determined to be a good product if the colloids in more than or equal to 4 regions of 9 regions had spherical appearance, otherwise, it was determined to be a bad product.

Based on the aforementioned, the present disclosure has the following characteristics.

Since colloids formed from various raw materials in the perovskite precursor solution can affect the performances of perovskite, analysis on the perovskite precursor solution can not only exclude variables of processes such as coating for film formation but also directly observe the association of qualities of the colloid and the precursor solution with perovskite by avoiding the destruction of the colloid caused by the formation of solid state, thereby establishing testing criteria for a perovskite precursor solution.

All of well-known methods for testing perovskite are back-end process testing methods, which are performed on thin films and crystals, if the poor quality can be found earlier by a method for testing perovskite precursor solution, subsequently subjecting a bad product to processes such as coating for film formation can be avoided, thereby reducing unnecessary waste and reducing cost.

The testing method of the present disclosure is suitable for various perovskite precursor solutions including unitary perovskite, binary perovskite and ternary perovskite, is also suitable for all-inorganic perovskite, all-organic perovskite and hybrid organic-inorganic perovskite, and thus has a broad range of applications; and the testing method disclosed herein retains the flexibility of adjusting the determination criteria according to needs, thereby conforming to different perovskite requirements.

It will be apparent to those skilled in the art that various modifications and variations can be made to the disclosed embodiments. It is intended that the specification and examples are considered as exemplary only, with a true scope of the disclosure being indicated by the following claims and their equivalents.

What is claimed is:

1. A method for testing a perovskite precursor solution, comprising:
taking the perovskite precursor solution containing a plurality of dispersed perovskite colloids as a sample to perform liquid analysis, thereby obtaining an analysis information; and
determining whether the perovskite precursor solution is a good product based on the analysis information obtained from the liquid analysis,
wherein the analysis information is at least one selected from the group consisting of element content of the colloid, element distribution, colloid size, and colloid appearance.

2. The method of claim 1, further comprising performing a pretreatment on the sample before performing the liquid analysis, wherein the pretreatment comprises heating, oscillating and filtering the sample.

3. The method of claim 2, wherein the heating is performed by elevating a temperature of the sample to a range of from 50° C. to 150° C.

4. The method of claim 2, wherein the filtering is performed by allowing the sample to pass through a screen of 0.1 μm to 1 μm.

5. The method of claim 2, wherein the pretreatment further comprises secondary heating, and the pretreatment comprises heating, oscillating, secondary heating and filtering the sample in sequence.

6. The method of claim 5, wherein the secondary heating is performed by elevating a temperature of the sample to a range of from 40° C. to 80° C.

7. The method of claim 1, wherein the perovskite precursor solution contains at least one solvent selected from the group consisting of dimethyl sulfoxide, dimethyl formamide, γ-butyrolactone and N-methylpyrrolidinone.

8. The method of claim 1, wherein the liquid analysis is at least one selected from the group consisting of scanning electron microscope (SEM) analysis, energy-dispersive X-ray (EDX) analysis and EDX mapping data image analysis.

9. The method of claim 1, wherein the perovskite precursor solution is determined to be a good product if perovskite colloids have an average colloid size between 4 μm and 15 μm, otherwise, it is determined to be a bad product.

10. The method of claim 1, wherein the perovskite precursor solution is determined to be a good product if more than 80% of perovskite colloids have a colloid size between 4 μm and 15 μm, otherwise, it is determined to be a bad product.

11. The method of claim 1, wherein the perovskite precursor solution is determined to be a good product if a perovskite colloid has appearance conforming to [(b/a)+(c/a)]/2≥80%, otherwise, it is determined to be a bad product, wherein a, b and c are a largest radius, a second largest radius and a smallest radius of the perovskite colloid, respectively.

12. The method of claim 1, wherein the perovskite colloid is a precursor for preparing perovskite represented by ABX₃, wherein:
A represents at least one monovalent cation selected from the group consisting of M₁, M₂ and M₃;
M₁ is an amine compound unsubstituted or substituted with a C₁₋₂₀ alkyl or a C₆₋₂₀ aryl, M₂ is an amidine compound unsubstituted or substituted with a C₁₋₂₀ alkyl or a C₆₋₂₀ aryl, and M₃ is at least one element selected from the group consisting of Cs, Rb, Li and Na;
B represents at least one element selected from the group consisting of Ca, Bi, Sr, Cd, Cu, Ni, Mn, Fe, Co, Pd, Ge, Sn, Pb, Sn, Yb and Eu; and
X represents at least one element or group selected from the group consisting of halogen, SCN and OCN.

13. The method of claim 12, wherein the perovskite represented by ABX₃ is a ternary perovskite, and A comprises monovalent cations of M₁, M₂ and M₃.

14. The method of claim 13, wherein the ternary perovskite is (MAₓFA_{y}Cs_{1-x-y})Pb(BrₐI₁₋ₐ)₃, wherein MA is CH₃NH₃⁺, FA is HC(═NH)NH₂⁺, x, y and a are equal to or less than 1, and 0.1<1−x−y<0.5.

15. The method of claim 12, wherein the perovskite precursor solution is determined to be a good product if the element represented by B in the perovskite colloid has a content of more than 5% and/or the halogen or sulfur in the element or group represented by X in the perovskite colloid has an element content of more than 10%, otherwise, it is determined to be a bad product.

16. The method of claim 12, wherein the perovskite precursor solution is determined to be a good product if, in the analysis information of element distribution, the position of the perovskite colloid overlaps with the dominate distribution position of the characteristic elements contained in perovskite, otherwise, it is determined to be a bad product.

17. The method of claim 1, wherein the perovskite precursor solution is determined to be a good product if, in the analysis information of element distribution, an EDX mapping data image of the perovskite precursor solution is divided averagely into two regions and a difference between average intensities of an oxygen element in two regions is ≤5 folds, otherwise, it is determined to be a bad product.

18. The method of claim 1, wherein the analysis information of the colloid appearance is an SEM image which is divided averagely into 9 regions, wherein the perovskite precursor solution is determined to be a good product if, in more than or equal to 4 regions of the 9 regions, more than 80% of perovskite colloids have appearance conforming to [(b/a)+(c/a)]/2≥80%, otherwise, it is determined to be a bad product, wherein a, b and c are a largest radius, a second largest radius and a smallest radius of the perovskite colloids, respectively.
